(19) United States
(12) Patent Application Publication
(10) Pub. No.: US 2011/0307308 A1
(43) Pub. Date: Dec. 15, 2011

(54) MARKETING PIECE EMPLOYING FOB AND METHOD OF MARKETING

(76) Inventor: Rusty Donohoo, Burlington, KY (US)

(21) Appl. No.: 12/813,953

(22) Filed: Jun. 11, 2010

(51) Int. Cl. G06Q 30/00; G06K 19/00

(52) U.S. Cl. 705/14.4; 705/1.1; 235/487

(57) ABSTRACT

A marketing piece includes an electronic device which is equipped to display a readable image upon actuation thereof which correlates to winning a prize upon presentation at a location where the prize is to be obtained. A method includes use of the piece.

### BACKGROUND OF INVENTION

1. Field of Invention

The present invention relates to a marketing device and method of marketing.

2. Prior Art

There exist prior marketing devices and methods. As it relates to the field of marketing by generating leads through drawing a customer into a store, the current marketing techniques include video, audio and direct mail. The direct mail approach itself includes various approaches to an effective marketing campaign. In recent years, direct mailers have included a promotional item attached to the mailer. For example, in the automobile industry, mailers have included a key which is intended to draw in a potential customer with the giveaway being a car, if the key fits the car. Otherwise the customer is provided some consolation gift for coming to the dealer.

While this has been somewhat effective, there remains a need to improve marketing approach. Accordingly, the present invention improves upon the current marketing approach.

### SUMMARY OF INVENTION

By virtue of the instant invention, there is provided an advertising vehicle through prolonged use of the marketing piece as opposed to a one time leader which may or may not be perfected.

It is an object to improve marketing.

It is another object to improve marketing pieces.

It is still another object to improve devices for marketing.

In one embodiment, the present invention is directed to a marketing piece which can include a substrate having at least one prize indicia printed thereon and an electronic device removably associated with the substrate which is equipped to display a readable image upon actuation thereof which correlates to winning the prize indicia shown on the substrate, wherein the electronic device can be brought to a location where the prize is to be obtained and displayed at such location.

The substrate can have coded indicia printed thereon correlating to the prize indicia wherein the readable image is a code which correlates to the coded indicia. There can be a plurality of prize indicia printed on the substrate and wherein the readable image upon correlates to winning at least one of the prize indicia shown on the substrate. The substrate can have coded indicia printed thereon correlating to each the prize indicia and wherein the readable image includes at least one code which correlates to at least one the coded indicia.

The electronic device can include a light beam device. The electronic device can include a processor, memory, an LCD display and power source. The electronic device can include software operably residing on the memory for enabling display of the readable image. Further, the electronic device can include an actuator for causing display of the readable image. The software is equipped to enable display of another message, such as a scrolling advertisement.

The electronic device can include an audible member. An actuator can be included for actuating the audible member. The software can be equipped to actuate the audible member at a predetermined time period for period of sounding an alarm. Additionally, the electronic device can include printed indicia thereon of a logo for a particular advertiser. One embodiment contemplates the use of a fob alone which includes the functionality of the electronic device.

Another aspect of the invention is directed to a method of marketing. The method includes the steps of: providing a marketing piece to a consumer, wherein the marketing piece can includes a substrate having at least one prize indicia printed thereon and an electronic device removably associated with the substrate which is equipped to display a readable image upon actuation thereof which correlates to winning the prize indicia shown on the substrate, wherein the electronic device can be brought to a location where the prize is to be obtained and displayed at such location.

### BRIEF DESCRIPTION OF THE DRAWINGS

FIG. 1 shows a schematic of the invention.

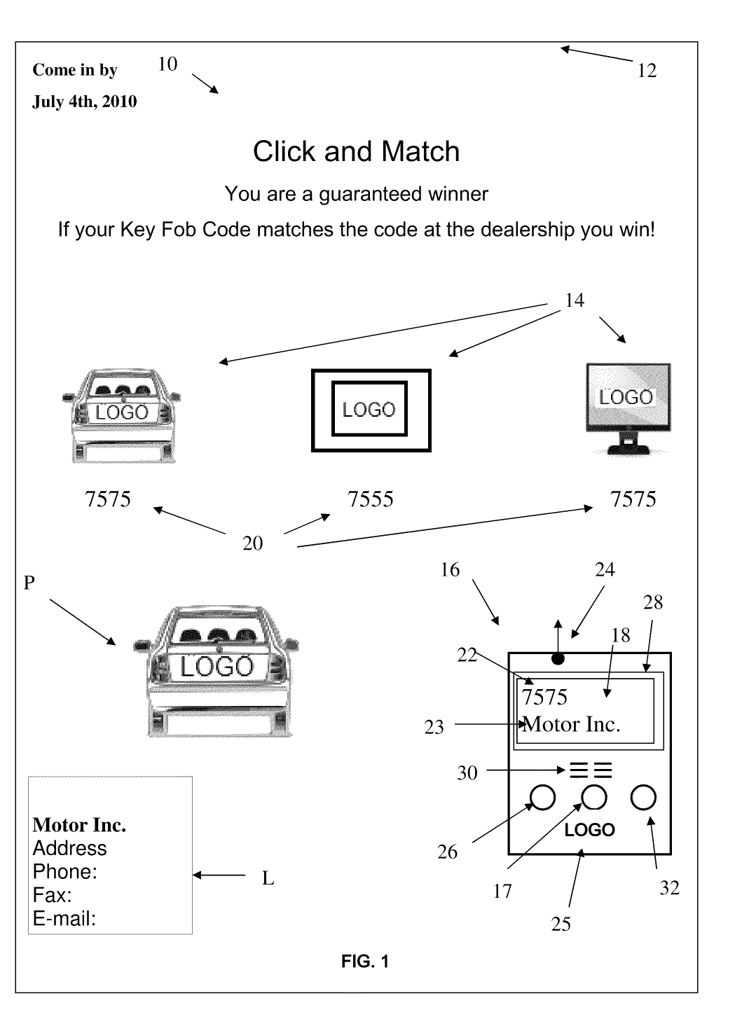

### DETAILED DESCRIPTION OF THE PREFERRED EMBODIMENTS

Referring now to the drawings, a marketing piece is generally referred to by the numeral 10. The marketing piece 10 contemplates several embodiments. In one case, it includes a substrate 12 having one or more prize indicia 14 printed thereon and an electronic device 16, such as a key fob, removably associated with the substrate 12 by way of a pressure sensitive adhesive, for example, or other suitable means, such as within an enclosed envelope configured for both the substrate 12 and the device 16. In another embodiment, it is contemplated that the fob 16 alone can serve as the marketing piece 10 as will be described hereinafter. The substrate 12 can be a paper based substrate with various advertisements printed thereon. Prize indicia 14 can include text and or images of a prize to be given away.

The electronic device 16 can be equipped to display a readable image 18 upon actuation of the device 16 by actuator 17 which correlates to winning the prize indicia 14 shown on the substrate 12. The electronic device 16 can be presented at a location L where the prize P is to be obtained, where such readable image 18 provides a code 22.

The substrate 12 can have coded indicia 20 printed thereon correlating to the prize indicia 14 wherein the readable image 18 includes code 22 which correlates to the coded indicia 20. There can be a plurality of prize indicia 14 printed on the substrate 12 and wherein the readable image 18 (code 22) correlates to winning at least one of the prize indicia 20 shown on the substrate 12.

The electronic device 16 can include a light beam device 24, which can include a laser diode, LED or other light. The electronic device 16 includes a light beam device actuator 26 for turning on the light beam device 24.

The electronic device 16 includes a processor, memory, power source, and an LCD display (collectively referred to by numeral 28). The electronic device 16 can include software operably residing on the memory for enabling display of the readable image 18 on the LCD display. The software is equipped to enable display of another message, such as a scrolling advertisement 23. A permanent logo 25 can be fixed on the device 16 to further provide an advertising tool.

The electronic device 16 can include an audible member 30, such as a sound chip operably connected to the processor. An audible actuator 32 can be included for actuating the audible member 30. The software can be equipped to actuate the audible member 30 to emit a sound, such as an alarm, at a predetermined time period for period.

Another aspect of the invention is directed to a method of marketing. The method includes the steps of providing a marketing piece 10 to a consumer. The marketing piece 10 includes substrate 12 having at least one prize indicia 14 printed thereon and an electronic device 16 removably associated with the substrate 12 which is equipped to display readable image 18 upon actuation thereof which correlates to winning the prize indicia 20 shown on the substrate 12. The electronic device 16 can be presented at location L where the prize P is to be obtained and displayed at such location L (as in the case of use of device 16 alone).

While the invention has been described for a marketing piece which can include both the substrate 12 and fob 16, it is envisioned that the fob 16 alone can serve as the marketing piece 10. For example, a casino may hand out the fob 16 to people who enter the casino and have a predetermined winning code 22 which can be viewed by actuating the electronic device 16.

The instant invention provides an advertising vehicle through prolonged use of the marketing piece as opposed to a one time leader which may or may not be perfected by the consumer. While the present invention has been set forth above in a preferred embodiment, it is contemplated that other modifications, improvements and derivations will be readily apparent to those skilled in the art. Accordingly, the appended claims hereto should be accorded the full scope of protection of any such modifications, improvements and derivations.

What is claimed is:

1. A marketing piece, which includes:
an electronic device which is equipped to display a readable image upon actuation thereof which correlates to winning a prize upon presentation at a location where the prize is to be obtained.

2. The marketing piece of claim 1, which includes a substrate having at least one prize indicia printed thereon which is removably associated with said electronic device and whereupon actuation said readable image displays a code which correlates to said prize indicia shown on said substrate.

3. The marketing piece of claim 2, wherein said substrate has coded indicia printed thereon correlating to said prize indicia and wherein said readable image is a code which correlates to said coded indicia.

4. The marketing piece of claim 2, which includes a plurality of prize indicia printed on said substrate and wherein said readable image upon correlates to winning at least one of said prize indicia shown on said substrate.

5. The marketing piece of claim 4, wherein said substrate has coded indicia printed thereon correlating to each said prize indicia and wherein said readable image includes at least one code which correlates to at least one said coded indicia.

6. The marketing piece of claim 1, wherein said electronic device includes a light beam device.

7. The marketing piece of claim 2, wherein said electronic device includes a light beam device.

8. The marketing piece of claim 1, wherein said electronic device includes a processor, memory, an LCD display and power source.

9. The marketing piece of claim 8, wherein said electronic device includes software operably residing on said memory for enabling display of said readable image.

10. The marketing piece of claim 9, which includes an actuator for causing display of said readable image.

11. The marketing piece of claim 9, wherein said software is equipped to enable display of another message.

12. The marketing piece of claim 11, wherein said message is an advertisement.

13. The marketing piece of claim 11, wherein said message is a scrolling message.

14. The marketing piece of claim 1, wherein said electronic device includes an audible member.

15. The marketing piece of claim 14, which includes an actuator for actuating said audible member.

16. The marketing piece of claim 8, wherein said electronic device includes an audible member.

17. The marketing piece of claim 16, which includes an actuator for actuating said audible member.

18. The marketing piece of claim 17, wherein said software is equipped to actuate said audible member at a predetermined time period for period of sounding an alarm.

19. A method of marketing, which includes the steps of:
(a) providing a marketing piece including an electronic device which is equipped to display a readable image upon actuation thereof which correlates to winning a prize; and
(b) actuating said electronic device at a location where the prize is to be obtained to display said readable image for purposes of obtaining the prize.

20. The method of claim 19, which includes providing a substrate having at least one prize indicia printed thereon and whereupon actuation said readable image displays a code which correlates to said prize indicia shown on said substrate.

21. The method of claim 20, wherein said substrate and said electronic device are removably associated with one another.

22. The method of claim 21, wherein said substrate and said electronic device are provided to a person.
